(19) United States
(12) Patent Application Publication
(10) Pub. No.: US 2009/0266150 A1
(43) Pub. Date: Oct. 29, 2009

(54) SENSOR CRITICALITY DETERMINATION PROCESS

(76) Inventor: Ari Novis, Rocky Hill, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/107,790

(22) Filed: Apr. 23, 2008

(51) Int. Cl. G01M 15/14

(52) U.S. Cl. 73/112.01

(57) ABSTRACT

A method and system of evaluating the criticality of parameters by evaluating consequences of a loss of capability to determine a desired operating parameter, identification of alternate means of obtaining the parameter, and assigning an importance value to the capability of determining the operating parameter. The resulting evaluation and identification is utilized to direct design and mitigation efforts.

An exemplary embodiment described in this disclosure was made with government support under Contract No.: EOS 7284315622 awarded by the Joint Program Office. The government therefore may have certain rights in this invention.

### BACKGROUND OF THE INVENTION

This disclosure generally relates to a system and method of evaluating and determining the criticality of sensors that monitor a propulsion system. More particularly, an exemplary embodiment described in this disclosure relates to a method of evaluating and identifying possible results of the loss of ability to monitor, measure or otherwise determine a parameter of a propulsion system.

A propulsion system for an aircraft such as a gas turbine engine includes a plurality of sensors that measure different operating parameters. Many of these sensors measure certain values that are utilized to derive other parameters that are in turn utilized to govern operation of the gas turbine engine. The loss or inability to monitor or derive certain engine operating parameters can result in undesired operation and wear of the propulsion system.

Each of these parameters needs evaluation to determine proper mitigation or back up requirements and desirability. Accordingly, it is desirable to design a process for methodically reviewing and evaluating each parameter measured for directing resources to most effectively address any concerns identified.

### SUMMARY OF THE INVENTION

The exemplary method identifies and categorizes the criticality of each sensor parameter such that resources can be directed to mitigate identified problems.

The example method includes the determination of the criticality of measured values by evaluating potential consequences caused by a loss of the capability to measure or determine a desired operating parameter on a system. Once this determination is made, another evaluation is conducted to identify alternate methods and means of obtaining the desired measured parameter. These evaluations and determinations are utilized to direct mitigation efforts and to reduce the probability of loss of an ability to detect or obtain one of the desired measured parameters.

Accordingly, the implementation of the disclosed method provides a methodical and efficient process of evaluating measured parameters and of directing efforts to mitigate the loss of any measured system parameter.

These and other features of the present invention can be best understood from the following specification and drawings, the following of which is a brief description.

### BRIEF DESCRIPTION OF THE DRAWINGS

FIG. 1 is schematic illustration of an example monitoring system for a gas turbine engine.

FIG. 2 is a flow diagram illustrating the example method.

FIG. 3 is a flow diagram illustrating the method steps utilized to determine if a parameter is mission essential or mission critical.

### DETAILED DESCRIPTION OF THE PREFERRED EMBODIMENT

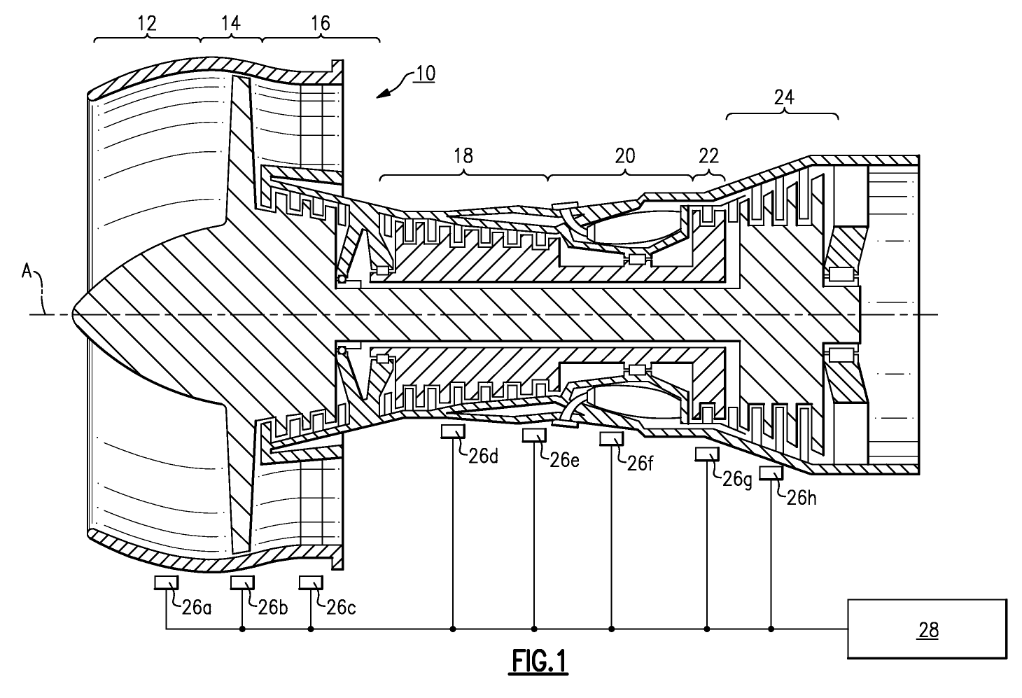

Referring to FIG. 1, a gas turbine engine 10, such as the illustrated turbofan gas turbine engine, is circumferentially disposed about an engine centerline A. The engine 10 includes an inlet module 12, a fan module 14, a low pressure compressor module 16, a high pressure compressor module 18, a combustion module 20, a two stage high pressure turbine module 22, and a low pressure turbine module 24. Each module typically includes a multitude of components. It should be understood that this schematic view is included to provide a basic understanding of the modules of the gas turbine engine, and not to limit the invention as this disclosure extends to all types of systems.

The example gas turbine engine 10 includes eight sensors 26a-h along the gas-path that provides information utilized to diagnose many different fault conditions. The eight sensors 26a-h measures various conditions that are indicative of engine operation. Information and measurements from the sensors 26a-h is forwarded to a controller 28. The controller 28 processes and stores this information for use during operation and for future reference to direct maintenance efforts. Loss of data from one or several of the sensors 26a-h can result in consequences ranging from loss of control and operation of the gas turbine engine 10 to the loss of the ability to identify premature wear of an engine part. The severity of the consequences of a loss of a measured parameter is utilized to focus and implement design and maintenance efforts.

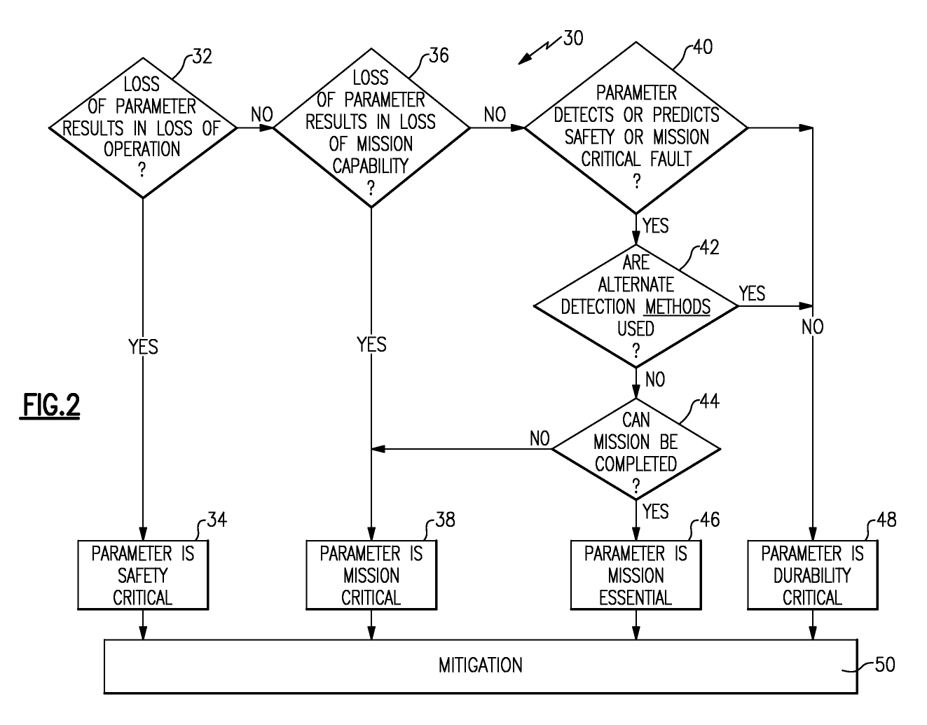

Referring to FIG. 2 with continued reference to FIG. 1, an example method schematically illustrated by the flow diagram 30 is utilized for evaluating the criticality and severity of consequences associated with the loss of a measured or derived parameter. This method will be described in reference to parameters derived from data obtained from sensors 26a-h that monitor the gas turbine engine 10, however, any complex system that utilizes sensors and other measured values to provide both data utilized during operation and for monitoring durability would benefit from this disclosure.

The example gas turbine engine 10 includes many parameters that are monitored to provide data relating to current operation and other parameters are utilized to measure durability related information. The example method 30 is utilized to determine and quantify consequences caused by the loss of a specific measured parameter. The term parameter as utilized in this specification refers to a feature or measurement that is either directly measured by one or more of the sensors 26a-h or derived by data obtained from one or more of the sensors 26a-h. The sensors 26a-h gather specific data relating to temperature, pressure, electrical current or other measurable features of the propulsion device. A parameter can be the specific measured value and also can be a value that is derived from information obtained from one or several of the sensors 26a-h.

The method 30 includes an analysis of each parameter to determine what effects would be caused if a measured or derived parameter was no longer available. This information and identification is utilized to focus the implementation of mitigation efforts and techniques as indicated at 50. The most severe consequences for the loss of a parameter would be loss of operation as indicated at 32. If the loss of data utilized to either derive or directly measure a parameter would result in the complete failure of the propulsion system then that parameter is determined to be a safety critical parameter as indicated at 34. A safety critical parameter is necessary of operation of the propulsion device. Examples of safety critical parameters include parameters that govern fuel flow, temperature and other such measurements that are required to control and maintain operation of the propulsion device. For example, if a fuel monitoring parameter utilized to calibrate and govern fuel flow is no longer available, then the proper fuel flow cannot be maintained. The inability to provide and maintain proper fuel flow could potentially result in loss of operation of the propulsion system.

If the loss of the parameter would not result in the loss of operation of the propulsion system, an analysis is conducted to evaluate if the parameter would reduce mission capability as indicated at 36. Mission capability is not essential for safe operation, but would reduce operation capability. As an example, the gas turbine engine 10 can include an augmentor for increasing thrust. The augmentor utilizes additional fuel that is injected into the hot gas stream. If parameters required to control this function are lost, the augmentor may not be operational thereby limiting potential mission capability. If such a capability is essential to a desired mission goal then that parameter is identified as a mission critical parameter as indicated at 38.

If the loss of the parameter being evaluated is not determined to be either safety critical 34, or mission critical 38, the parameter is evaluated to determine if the parameter is mission essential as indicated at 46. Mission essential parameters lost during a flight will not cause the mission to be aborted, but will be need to be repaired before the next mission. Mission essential parameters include, for example, parameters used for the monitoring of faults, whereas safety critical and mission critical involved parameters used to control the engine. The mission essential analysis of the parameter includes an initial analysis, indicated at 40, to evaluate if the parameter provides the capability to monitor the health or deterioration of safety critical 34 or mission critical 38 components but does not itself restrict the capability to continue normal mission operation.

A parameter that is utilized only to detect a fault condition is not in and of itself detrimental to current operation of the gas turbine engine 10. For example, during propulsion system design, a failure mode analysis is performed. This failure mode analysis evaluates and categorizes mechanical and electrical components for known failure modes such as breaking, leaking, and other loss of function, and evaluates effects of each failure mode on the propulsion system.

Parameters used by the propulsion control system that are used to either detect these failure modes, or detect precursors to these failure modes are examples of parameters that are categorized as mission essential 46. In the case of detecting the failure mode, this detection provides for the proper accommodation of the fault when the propulsion system is capable of accommodation. Accordingly, once the parameter is determined at 40 to detect or predict a safety critical parameter 34 or mission critical parameter, an analysis is undertaken to determine if alternate methods of obtaining the parameter are available as indicated at 42. An example would be to use the parameter of fuel pressure to detect the lack of pressure due to the failure of a fuel pump, with the accommodation being switching to a back-up pump. In the case of detecting the precursor of the failure mode, detection allows accommodation by scheduling replacement of the failing component before it fails completely. Another, example of alternate detection methods would be to use a vibration measurement parameter to detect increased vibration due to pitting and damage in a rotating bearing race, with the accommodation being to replace the bearing at the next opportunity before the damage progresses to failure and shuts down the propulsion system.

If acceptable alternate tests are available as determined at 42, then the parameter is categorized as being durability critical as is indicated at 48. The durability critical parameter as indicated at 48 is a parameter that provides a diagnostic function. If the diagnostic function is lost, the propulsion system will not necessarily result in a loss of ability. The impact will be more on an economic basis rendering maintenance diagnostics unable to determine if parts are wearing abnormally.

If faults detected by the parameter under evaluation can also be detected by some combination of other parameters, then the parameter under evaluation is not mission essential, but is durability critical 48. As an example, a vibration parameter can be used to determine if a bearing race is starting to fail by pitting and losing material. If the propulsion diagnostic system also includes a parameter that indicates bearing debris in the oil, then that parameter could be utilized as an alternate method for detecting that fault. The durability critical determination indicated at 48 is utilized to identify those parameters that impact durability but not current operation of a part of the propulsion system 10.

If acceptable alternate detection methods are not available as determined at 42, a further analysis is conducted to determine if a mission can be completed, as indicated at 44, even without alternate detection methods. If the analysis at 44 results in a determination that loss of the parameter would result in a loss of the ability to complete a mission, that parameter is determined to be mission critical 38. If the analysis at 44 of the parameter results in a determination that the mission could be completed, the parameter is categorized as being mission essential 46.

The mission essential identification 46, applies to a fault that will prevent the detection of a fault required for proper operation of the propulsion system, not an actual fault. This identification reflects the determination that some probability that a mission-ending fault could occur and not be detected because the parameter used to monitor it has been lost. This identification provides for the further analysis of the probability of the mission-ending fault occurring in view of other operational factors.

As an example, if the example gas turbine engine augmentor is necessary to complete the mission, and a parameter needed to determine if the augmentor is functional has been lost, there is a possibility that the augmentor may not function when needed, and the mission will not be completed successfully. Depending on information know about the reliability of the augmentor, the mission may be continued or aborted. If based on this further analysis it is determined that mission should be aborted, the parameter can be identified as mission critical 38. Accordingly, if the further analysis determines that the augmentor is sufficiently reliable to continue without the monitoring parameter, than that parameter is identified as mission essential 46.

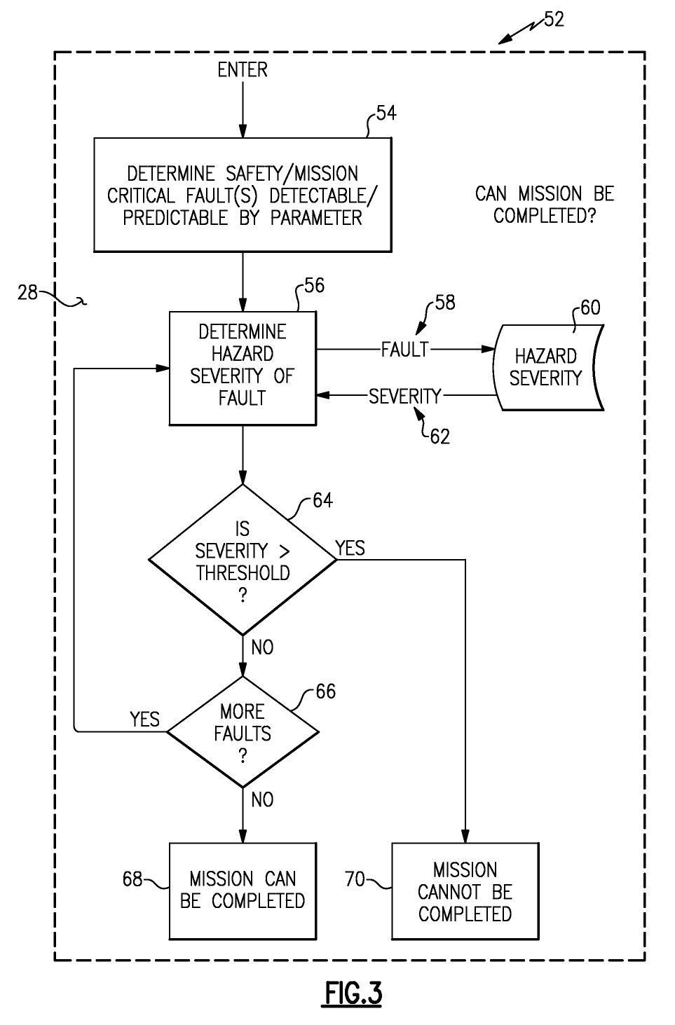

Referring to FIG. 3 with continued reference to FIGS. 1 and 2, a system 52 of determining and identifying the consequences of the loss of a specific parameter is generally indicated. The method of evaluating consequences of a loss of parameter is performed by the system 52. It should also be noted that the controller 28 comprises a computing device used to implement various functionality, such as that attributable to the method of evaluating the effects caused by the loss of a parameter. In terms of hardware architecture, such the computing device can include a processor, a memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The system 52 includes an initial analysis 54 for evaluating a criticality of the parameter. The criticality of a parameter is determined to be safety critical 34, mission critical 38 or a parameter utilized to detect a fault condition 40. Identification of the parameter is as indicated and discussed with reference to FIG. 2.

Once the parameter is categorized, a further analysis is conducted as indicated at 56 to determine a hazard or severity of any of the faults that could occur and go undetected upon the loss of this detected parameter. The analysis of a hazard and severity includes analysis of what faults as indicated at 58 could occur in the absence of a parameter. An analysis identifies and evaluates consequences that such an unidentified fault could have on the propulsion system as indicated at 60. The result is an identified and severity ranking 62 that is utilized for to further evaluate and categorize the evaluated parameter. The severity of a fault caused by a loss of a specific parameter could range from the extreme case of total inoperability of the propulsion system to a minor case where loss of the parameter merely prevents detection of a durability parameter.

The identified severity ranking is fed back into the evaluation as indicated at 62 and another determination is made to determine if the severity is beyond an acceptable threshold value indicated at 64. An acceptable threshold is determined according to application specific requirements and is evaluated in view of what is required in view of whether or not a mission can be completed. If the severity threshold is exceeded as determined by the severity ranking 62, the loss of the parameter is identified as an instance where a mission cannot be completed as indicated at 70.

However, if the threshold value is not exceeded, another evaluation is conducted to determine if additional faults occur as is indicated at 66 whether or not the mission can be completed or further evaluation is required. If additional faults are possible in response to the loss of the evaluated parameter, analysis returns to determine severity as indicated at 56 of the additional faults. The analysis proceeds with further evaluation of the additional faults. The additional faults are further ranked for severity and evaluated against a severity threshold as indicated at 64.

Once no further faults are identified, and the severity threshold is not exceeded, the parameter can be determined to be such that a mission can be completed as indicated at 68.

Referring to FIG. 2, upon the evaluation of the many parameters utilized to govern control and measure operation of a propulsion device such as the example gas turbine engine 10, a further evaluation and focus can be conducted to evaluate mitigation as indicated at 50. The design and implementation of mitigation processes and devices is implemented according to a ranking provided by the identifications assigned each of the system parameters. The mitigation process utilizes the assigned identifications of safety critical, mission critical, mission essential, and durability critical to efficiently direct resources. Mitigation can be provided in the form of the use of redundant sensors or of sensors that measure other values that can be utilized to derive the desired parameter or some combination of both.

This example process 30 and system 52 is utilized to identify and evaluate each parameter utilized in the operation of a complex system such as the example gas turbine engine 10 in order to focus the design of data gathering and measuring schemes including sensor placement and further devices for obtaining mission critical and safety critical parameters.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of evaluating a criticality of a system parameter comprising:
evaluating potential consequences resulting from an absence of a system value;
identifying alternate means of obtaining information determined utilizing the system parameter;
assigning an importance to the system parameter; and
adjusting at least one means of obtaining the system parameter responsive to the evaluation of possible consequences and alternate means of obtaining information.

2. The method as recited in claim 1, where the evaluation of potential consequences resulting from the absence of the system parameter includes determining an effect that the absence of the system parameter will have on performance of a propulsion device.

3. The method as recited in claim 2, wherein the effects on the performance of the propulsion device includes a determination that the loss of the system parameter will result in at least one of a total failure, partial failure and an ability to detect a total or partial failure.

4. The method as recited in claim 1, further including performing actions that reduce a likelihood of a loss of the system parameter resulting in at least one of the total failure, partial failure and the ability to detect the total or the partial failure.

5. The method as recited in claim 1, wherein identifying alternate means of obtaining the information includes one of identifying alternate system parameters that provide data that directly duplicates the system parameter and identifying different system parameters that can be utilized to derive the desired information.

6. The method as recited in claim 1, including identifying if a desired operation can be completed without the system parameter.

7. A method of evaluating the criticality of parameters for a propulsion system, the method comprising:
evaluating consequences of a loss of a capability to determine a desired propulsion system operating parameter;
identifying alternate means of obtaining a value indicative of the desired propulsion system operating parameter; and
assigning an importance to the capability of determining the desired propulsion system operating parameter in view of the evaluated consequences and the identified alternate means of obtaining a value indicative of the desired propulsion system operating parameter.

8. The method as recited in claim 7 including adjusting a process of obtaining the operating parameter responsive to the assigned importance and the evaluated consequences.

9. The method as recited in claim 7, wherein evaluating consequences includes the determination that the loss of a capability to determine a desired propulsion system operating parameter would result in total loss of propulsion system performance and therefore is safety critical.

10. The method as recited in claim 7, wherein evaluating consequences includes the determination that the loss of a capability to determine a desired propulsion system operating parameter would result in loss of a mission critical capability and therefore is mission critical.

11. The method as recited in claim 7, wherein evaluating consequences includes the determination that the loss of a capability to determine a desired propulsion system operating parameter would result in a loss of a capability to detect a failure in at least one of a safety critical and a mission critical parameter.

12. The method as recited in claim 11, including determining that a parameter is durability critical responsive to identification of alternate means of obtaining the desired propulsion system parameter.

13. The method as recited in claim 12, including determining that a parameter is mission essential responsive to a determination that no alternate means of obtaining the desired propulsion system parameter are available.

14. The method as recited in claim 12, including assigning the parameter as mission essential critical responsive to determining that a mission cannot be completed without the capability of monitoring the propulsion system operating parameter.

15. A system for evaluating a criticality of a system parameter comprising:
a controller operable for categorizing a system parameter based on potential consequences caused by a loss of the system parameter, assigning an importance to the system parameter based on the potential consequences, and ranking each system parameter based on the importance to the system.

16. The system as recited in claim 15, wherein the controller is operable to identify alternate means of obtaining information provided by the system parameter and utilizing the identified alternate means to determine the rank of the system parameter.

17. The system as recited in claim 16, where the controller is operable for evaluating potential consequences resulting from the absence of the measured value includes determining an effect that the absence of the measured value will have on performance of a propulsion device.

18. The system as recited in claim 17, wherein the effects on the performance of the propulsion device includes a determination that the loss of the measured value will result in at least one of a total failure, partial failure and an ability to detect a total or partial failure.
